(19) United States
(12) Patent Application Publication
(10) Pub. No.: US 2008/0010690 A1
(43) Pub. Date: Jan. 10, 2008

(54) Method for Protecting an Electronic Chip

(75) Inventor: Gilles Delapierre, Seyssins (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, PARIS (FR)

(21) Appl. No.: 11/660,950

(22) PCT Filed: Sep. 19, 2005
(86) PCT No.: PCT/FR05/02312

§ 371 Date: Feb. 23, 2007

(30) Foreign Application Priority Data
Sep. 24, 2004 (FR) 0410110

(51) Int. Cl. G06F 21/00; H01L 21/00

(52) U.S. Cl. 726/34; 438/51; 257/E21.002

(57) ABSTRACT

An electronic chip is self-protected by formation of at least part of an electronic circuit of the chip on a thin rigid membrane arranged between first and second cavities that are normally at a substantially identical pressure, much higher than atmospheric pressure. An attempted intrusion, causing a pressure reduction in one of the cavities, creates a pressure difference that breaks the membrane and makes the chip inoperable.

### BACKGROUND OF THE INVENTION

The invention relates to a method for protecting an electronic chip, a self-protected electronic chip, and also a method for producing the chip.

### STATE OF THE ART

Electronic chips are being more and more extensively used, in particular in chip cards, as control means for financial operations, for controlling access or for checking identity. Increasingly frequent and sophisticated attempted frauds are leading chip card providers to enhance the safety of their cards.

Different types of protection have been developed taking various types of fraud into account. For example, swindlers can use observation of the electrical behavior of the chip, in particular the variations of its supply current, disassembly and/or direct observation of the circuit. Protection against attacks involving purely electrical observation is generally performed by software, for example by providing instructions which jam the messages (by adding bait switchings, for example). To prevent, or at least limit, the possibilities of direct observation of the circuit, the latter is generally located in a sealed casing.

It does however remain possible to open the protective casing of the circuit to observe its operation in detail and to understand and get round its protection means. To enhance safety, it has already been proposed to destroy the circuit as soon as an attempt to perform a physical intrusion is detected. This does however imply the following simultaneous conditions:
that the intrusion is detected,
that the chip contains destruction means embedded on the chip,
that the embedded destruction means are not disconnectable,
that the destruction means are inexpensive,
that the destruction means do not trigger spuriously.

In known protection methods, destruction of the circuit is in particular achieved either by means of an electrical pulse, for example by using a fuse, or by activating explosive micro-charges. In all cases, a power source has to be embedded on the chip and an intrusion sensor has to be included in the casing. Such protective devices are complex and consequently expensive, and a risk of deactivation may remain, in particular in so far as the electric power source can discharge.

### OBJECT OF THE INVENTION

The object of the invention is to remedy these shortcomings and, more particularly, to provide an inexpensive method for protecting an electronic chip.

According to the invention, this object is achieved by the fact that at least a part of an electronic circuit of the chip is formed on a thin rigid membrane arranged between first and second cavities, normally at a substantially identical pressure that is much higher than atmospheric pressure, an attempted intrusion causing a reduction of the pressure in one of the cavities creating a pressure difference that breaks the membrane.

In a self-protected electronic chip according to the invention, at least a part of an electronic circuit of the chip is formed on a thin rigid membrane arranged between first and second cavities wherein the pressure is normally much higher than atmospheric pressure.

A method for producing a chip according to the invention comprises formation of at least one communication hole passing through the membrane, pressurizing of the first and second cavities connected via said communication hole, and sealing of said communication hole.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 illustrates the protection principle of an electronic chip according to the invention.

FIGS. 2 to 5 illustrate the successive steps of a particular embodiment of a method for producing a self-protected chip according to the invention.

FIGS. 6 and 7 respectively represent a particular embodiment for partial sealing of a communication passage of a chip according to the invention in cross-section and in top view.

FIGS. 8 to 11 illustrate the successive steps of another particular embodiment of a method for producing a self-protected chip according to the invention.

FIGS. 12 and 13 illustrate alternative embodiments of the method according to FIGS. 8 to 11.

FIG. 14 represents an alternative embodiment of support elements of the membrane of an electronic chip according to the invention, in top view.

### DESCRIPTION OF PARTICULAR EMBODIMENTS

According to the invention, protection of the electronic chip is achieved by destruction of at least a part of the electronic circuit comprised therein, without requiring either an intrusion sensor, or an embedded electric power source, or an electric circuit commanding destruction.

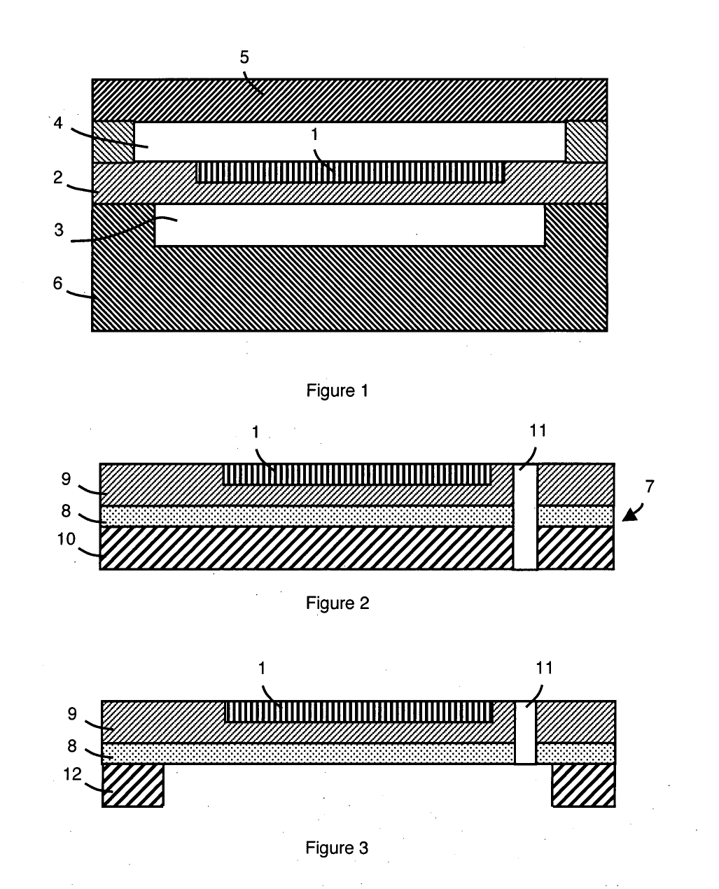

As represented in FIG. 1, the electronic circuit 1 of the chip is formed on a membrane 2 arranged between two cavities 3 and 4. The cavities 3 and 4 are, in normal operation, at a substantially identical high pressure, much higher than atmospheric pressure. The thin rigid membrane 2 is thus subjected to this high pressure on the two opposite faces thereof. The first cavity 3 is preferably arranged under the membrane, whereas the second cavity 4 is arranged between the membrane 2 and a protective cover 5.

An attempted intrusion, via the front face of the electronic chip, through the cover 5, or via the rear face thereof, through a substrate 6, automatically causes a leakage and consequently a sharp reduction of the pressure in one of the cavities 3 and 4. The membrane is then subjected to a large pressure difference, which has to be sufficient for the latter to break, thus causing destruction of the electronic circuit which it supports.

When the intrusion takes place, one of the cavities thus drops very quickly to atmospheric pressure, whereas the other cavity remains at the initial pressure, which is much higher than atmospheric pressure. In a preferred embodiment, the initial high pressure is about 10 bars, which leads for example, when an intrusion takes place, to a pressure difference of about 9 bars. The membrane 2 is preferably formed by a thin layer of silicon.

An order of magnitude of the thickness of the membrane 2 can be obtained from the following formula which applies in the case of a circular membrane:
T=3Pr²/8h²
in which T is the tensile strength or stress limit of the membrane, P the pressure difference applied on the membrane, r the radius of the membrane and h its thickness.

For example, for a diameter of 1 mm, an initial internal pressure of 10 bars in the cavities, i.e. a pressure difference of 9 bars in the event of an intrusion, and a tensile strength of 1 Gpa, the membrane must have a thickness of less than 12 μm to break.

A large number of other pressure, surface and membrane thickness combinations are naturally possible. In addition, certain zones of the membrane can be previously weakened, for example by etching weakening grooves when the chip is fabricated. It is moreover possible to limit the electronic circuit, arranged on the membrane 2 arranged between the two cavities 3 and 4, to certain sensitive parts only. Destruction of the membrane in the event of an intrusion then causes destruction of these sensitive parts, which is sufficient to prevent any observation and subsequent use of the chip.

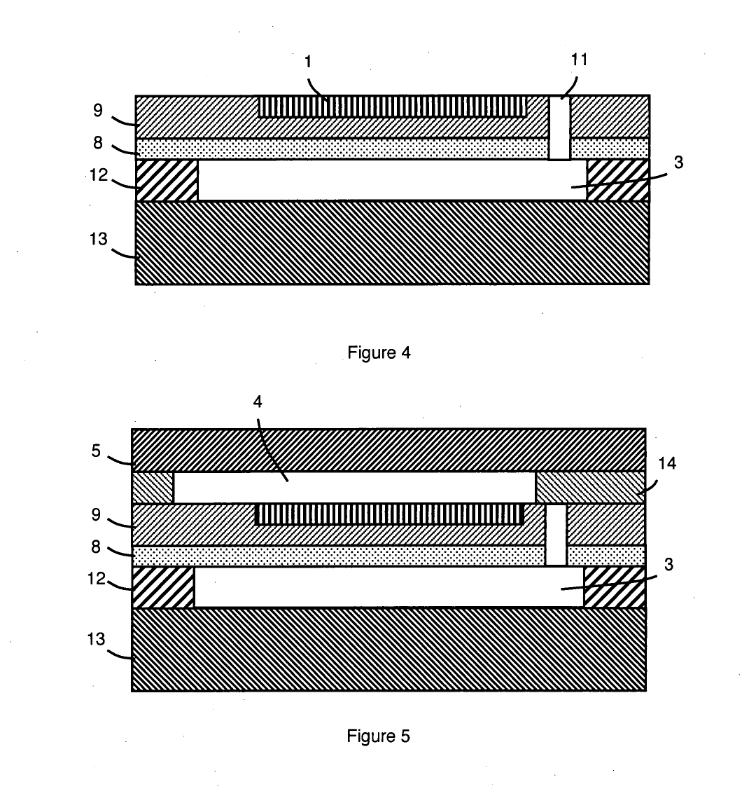

The successive steps of a particular embodiment of a method for producing a self-protected chip are illustrated in FIGS. 2 to 5.

In FIG. 2, the electronic circuit 1 of the chip or, if such is the case, only certain sensitive parts of the circuit, is formed in conventional manner in silicon on insulator (SOI) technology on a substrate 7 comprising a buried oxide (SiO₂) layer 8 between two silicon layers, respectively a front layer 9 and rear layer 10. A communication hole 11 is formed next to the circuit 1, through the substrate 7, for example by etching.

The first cavity 3 is then formed in two steps. First of all, as represented in FIG. 3, the substrate 7 is selectively etched via the rear face thereof, for example through a mask that is not represented, with etching being stopped on the buried oxide layer 8, so that all that is left of the rear layer 10 of the substrate 7 is a peripheral zone 12 designed to delineate the first cavity 3 laterally. Then, as represented in FIG. 4, a rear substrate 13 is sealed onto the peripheral zone 12. The first cavity 3, or rear cavity, is thus delineated at the front by the buried oxide layer 8, at the rear by the rear substrate 13 and laterally by the peripheral zone 12 of the rear layer 10 of the substrate 7. The sealing technique used can be of any known type, provided that the sealing temperature does not exceed the maximum temperature acceptable by the circuit 1. For example, it is possible to use a glass-silicon anodic sealing, a fusible glass sealing fillet or direct sealing techniques by low-temperature molecular adhesion.

A first cavity 3 can thus be easily achieved that is sufficiently deep for the membrane 2 not to come up against the stop formed by the bottom of the cavity 3 before breaking, when an intrusion is made via the rear face of the chip (the pressure in the second cavity 4 remains high, whereas the pressure in the first cavity 3 decreases to atmospheric pressure and the membrane deforms in the rearward direction). In the previously described example (diameter of 1 mm, tensile strength of 1 Gpa, membrane thickness smaller than 12 μm), for a pressure difference of 9 bars, the deflection of the membrane is about 30 μm before breaking. The depth of the cavity 3, corresponding to the thickness of the silicon rear layer 10, therefore has to be greater than this value.

It is also desirable, when dimensioning the cavity 3, to take account of the pressure variation in this cavity due to deformation of the membrane 2 when an intrusion is made via the front face (the pressure in the second cavity 4 decreases to atmospheric pressure, whereas the first cavity 3 remains at a much higher pressure than atmospheric pressure and the membrane deforms in the frontward direction). The product PV of the pressure P in the cavity by the volume V of this cavity does in fact remain constant in the cavity 3, which does not present any leak. If this cavity is too thin, the increase of its volume V is, proportionally, quickly very large when deformation of the membrane takes place and the pressure in the cavity 3 decreases in the same proportions, quickly reducing the pressure difference exerted on the membrane. However, the method described above enables cavities having a depth of about 500 μm to be easily produced, which depth is more than 10 times larger than the deflection of the membrane, thus enabling this problem to be overcome.

Numerous other known fabrication techniques can be used to form the first cavity 3. This is in particular the case of circuit thinning and transfer techniques. The circuit can for example be stuck on a substrate and thinned before being transferred onto another substrate comprising the cavity.

As represented in FIG. 5, the chip is then completed by sealing of the protective cover 5 under high pressure, the second cavity 4 being arranged between the membrane 2 and the cover 5. The communication hole 11 enables the pressures in the two cavities 3 and 4 to be equalized before and/or during sealing. This hole can, as represented in FIG. 5, be closed off by the sealing fillet 14, for example made of fusible glass, which is arranged between the membrane 2 and the protective cover 5 so as to cover the communication hole 11.

Several communication holes 11 can be provided and other solutions can be used to seal the communication holes 11. In an alternative embodiment, the communication holes can be closed off after the protective cover 5 has bee n sealed. This solution leaves more freedom in the choice of location of the communication holes 11. It is in particular possible to deposit a polysilicate glass (PSG) film on the membrane, for example by chemical vapor deposition (CVD), around the communication hole 11, and to perform a high-temperature heating step, after sealing of the protective cover 5 has been performed, resulting in creeping of the film and sealing of the communication hole by the crept glass. However, a material has to be used that creeps at a temperature comprised between the sealing temperature of the protective cover 5 and the maximum temperature able to be supported by the circuit 1, which may be difficult to achieve.

A passage with a low hydraulic conductance can be maintained between the cavities 3 and 4. This passage has to be sufficient to enable the pressures in the two cavities to be kept at equilibrium in the event of a slow variation of the pressures, but not in the event of a sharp variation of the pressure in one the cavities, so as to maintain the formation of a sufficient pressure difference to break the membrane in case of intrusion. The communication hole 11 can then be closed before the cover is sealed.

In a first alternative embodiment (not represented), the communication holes 11 are totally sealed and an additional or capillary hole having a very small diameter, preferably smaller than one micron, is formed in the membrane 2, for example by etching, next to the circuit 1. Such an alternative embodiment presents the advantage of being tolerant to dispersions due to the technology.

In a second alternative embodiment (not represented), the communication holes 11 are sealed by a sealing material that is sufficiently porous to enable the pressures in the first and second cavities 3 and 4 to be kept at equilibrium in the event of a slow variation of the pressures, for example during sealing of the protective cover, but not sufficiently porous to enable the pressures to be kept at equilibrium in the event of a sharp variation of the pressure in one the cavities. For example, the sealing material can be formed by polysilicate glass (PSG), which thus fills the communication holes 11 reducing the cross-section thereof without closing them completely.

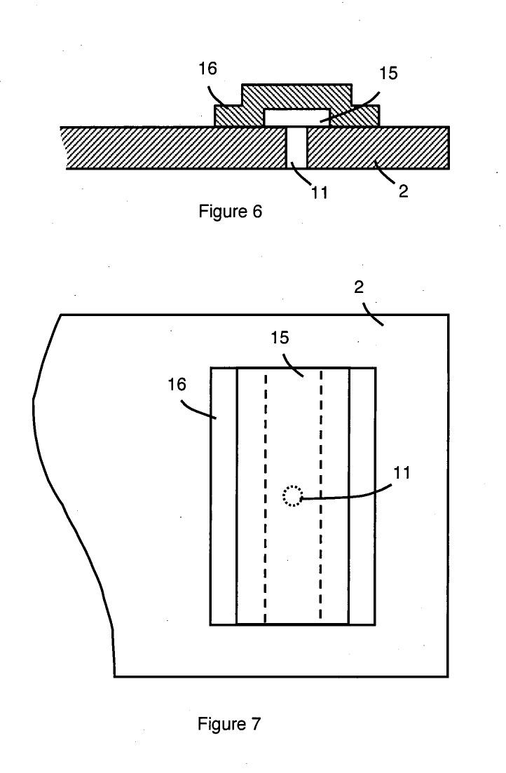

In a third alternative embodiment, illustrated in FIGS. 6 and 7 which only reproduce one end of the membrane, the low hydraulic conductance passage is formed, on the membrane 2, by a small channel 15 constituting a capillary. The channel 15 is perpendicular to the hole 11 and communicates with the latter. It is preferably formed in a thin metal layer 16 covering the communication hole 11, for example by known techniques using a polymer-base sacrificial layer. The two ends of the channel, respectively at the top and bottom in FIG. 7, remain open and thereby communicate with the inside of the corresponding cavity. The pressures can therefore be equalized, through the channel 15 and the communication hole 11, in the event of a slow variation of the pressures.

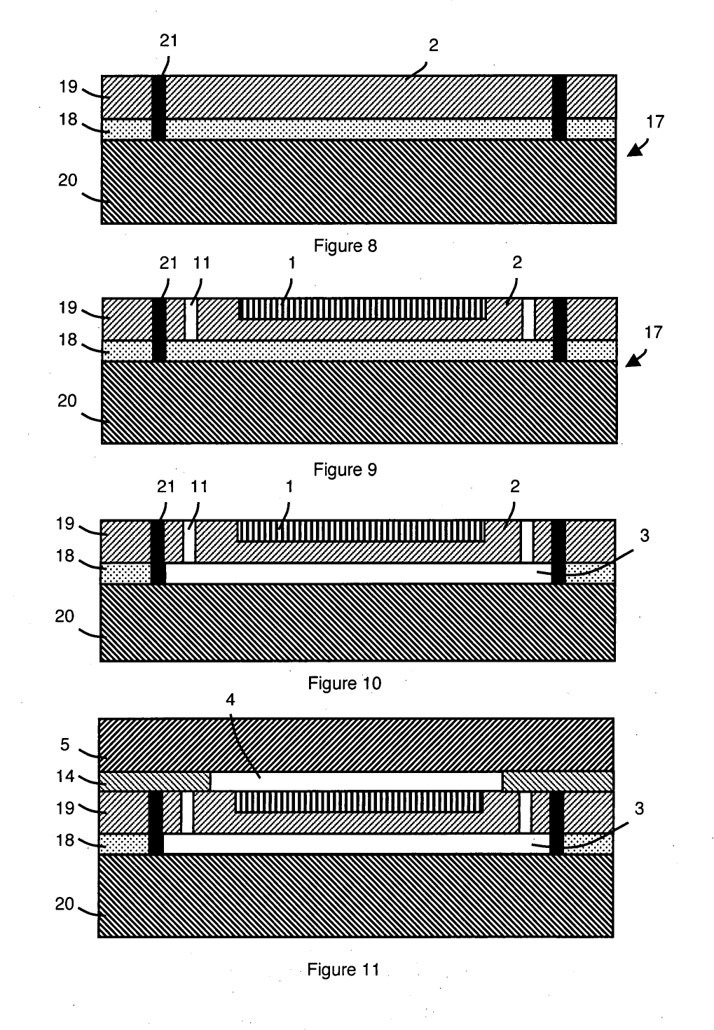

FIGS. 8 to 11 illustrate the successive steps of another particular embodiment of a method for fabricating a self-protected chip using the sacrificial layer technique.

In FIG. 8, the chip is formed by silicon on insulator (SOI) technology from a substrate 17 comprising a buried oxide (SiO₂) layer 18 between two silicon layers, respectively the front layer 19 and rear layer 20. A fillet 21 is etched, around the zone designed to carry the electronic circuit 1, in the front silicon layer 19 and in the buried oxide layer 18, through which it passes. The membrane 2 is formed by the part of the front silicon layer 19 that is laterally delineated by the fillet 21. The latter is filled with silicon nitride (Si₃N₄), for example by chemical vapor deposition (CVD). The nitride deposited on the surface of the substrate 17 is eliminated by any suitable means, for example by Chemical Mechanical Polishing (CMP) or by chemical etching.

As represented in FIG. 9, the electronic circuit 1 is then formed, in conventional manner, on the front face of the substrate 17, in the zone delineated by the fillet 21. At least one communication hole 11 is formed in this zone, next to the electronic circuit 1, for example by etching in the front layer of silicon 19.

The first cavity 3, arranged under the membrane 2 and laterally delineated by the fillet 21, is then formed in the buried oxide layer 18, by etching of the buried oxide layer 18 through the communication hole(s) 11. The buried oxide layer 18 thereby acts, in this case, as sacrificial layer for formation of the first cavity 3.

In FIG. 11, as in the embodiment represented in FIG. 5, the chip is then completed by sealing of the protective cover 5 under high pressure, the second cavity 4 being arranged between the membrane 2 and the cover 5. As previously, the communication hole(s) 11 enable(s) the pressures in the two cavities 3 and 4 to be equalized before and/or during sealing. These holes can, as represented in FIG. 11, be closed by the sealing fillet 14, for example made of fusible glass, that is deposited between the membrane 2 and the protective cover 5 so as to cover the communication holes 11.

In the embodiments illustrated in FIGS. 8 to 13, the thickness of the buried oxide layer 18 defines the depth of the first cavity 3. Dimensioning of the different elements of the chip has to take account of this depth and of the possible movement of the membrane 2. But the substrates 17 used in silicon on insulator technology do however commonly have a buried oxide layer 18 with a thickness of 3 μm. The membrane 2 then has to have a sufficiently small diameter to enable it to reach its yield limit before coming into contact with the bottom of the first cavity 3. With the same pressure of 10 bars as in the previous example, the diameter of the membrane then has to be less than or equal to 0.1 mm. It is then possible to only form a strategic part of the electronic circuit 2 on the membrane 2, i.e. a part which when destroyed makes it impossible to use the chip.

A membrane having a thickness of about 1.5 μm can then be used. Such a thickness, although envisageable, may be a little small to be able to fit the electronic circuit 1 therein. An alternative consists in using a thicker membrane with zones that have been previously weakened, for example by formation of weakening grooves in the membrane.

The front silicon layer 19 can for example be thickened by epitaxy so as to form an epitaxied silicon layer on the front silicon layer 19, in order to form a thicker membrane 2. This epitaxy is preferably performed before formation of the fillet 21. The fillet 21 and the communication holes 11 then pass through this epitaxied layer. Weakening grooves can then be formed in the membrane.

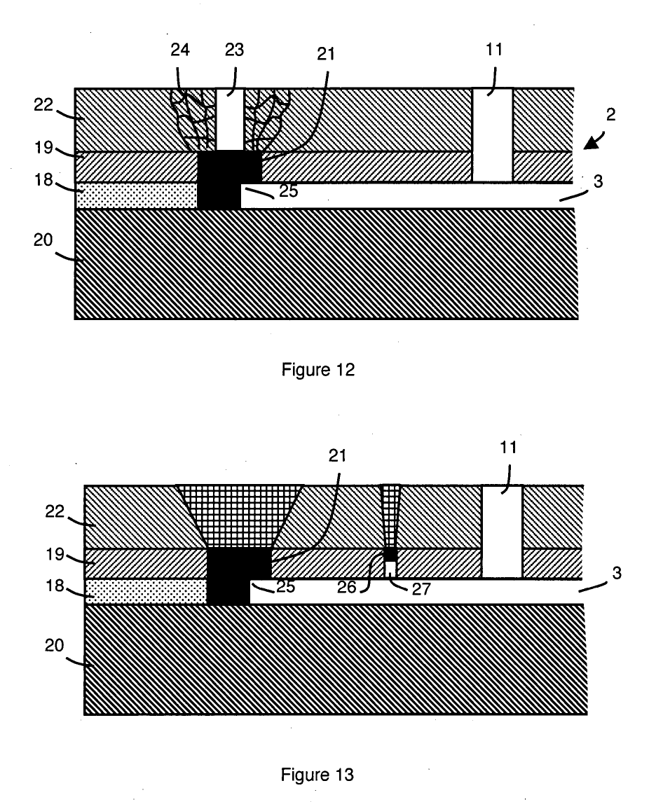

In an alternative embodiment illustrated in FIG. 12, after etching and filling of the fillet 21 with silicon nitride, an epitaxied silicon layer 22 with a thickness of a few microns is formed on the front silicon layer 19, which can initially have a thickness of about 0.2 μm. A weakening groove 23 can then be etched in the epitaxied silicon layer 22, preferably facing and above the fillet 21. A fragile zone 24 made of polycrystalline silicon with a high strain concentration thus automatically forms in the layer 22, at the periphery of the weakening groove 23, fragilizing the membrane at the periphery thereof.

At the same time, formation, as in FIG. 10, of the first cavity 3 by etching of the buried oxide layer 18 through the communication hole(s) 11, results, as represented on an enlarged scale in FIG. 12, in overetching 25 of the base of the fillet 21 disposed in the layer 18. Indeed, although it is lower than that of the silicon oxide (SiO₂) of the layer 18, the etching speed of the silicon nitride (Si₃N₄) filling the fillet 21 is not nil. The fillet 21, which acts as anchoring pillar for the membrane 2, is thus weakened at its base.

In the alternative embodiment illustrated in FIG. 13, the overetching phenomenon is further used to weaken the membrane at predetermined locations of the central part thereof. Thin weakening holes or trenches 26 are therefore etched, at the same time as the fillet 21, in the front silicon layer 19 and in the layer 18, and pass through these layers. The weakening holes or trenches 26 are filled with silicon nitride at the same time as the fillet 21. An epitaxied silicon layer 22 can then be formed on the front layer 19. The diameter or width of the weakening holes/trenches 26, preferably less than a micron, is sufficiently small for etching of the buried oxide layer 18 for formation of the first cavity 3 to result in total etching of the silicon nitride which they contain in the layer 18, and at least partial etching or overetching 27 in the membrane which is thereby weakened. The weakening holes/trenches 26 are preferably arranged fairly close to the communication holes 11, which are used for etching of the first cavity 3 in the buried oxide layer 18, in FIG. 13, after etching of the fillet 21 and of the weakening holes/trenches 26 and filling thereof with nitride.

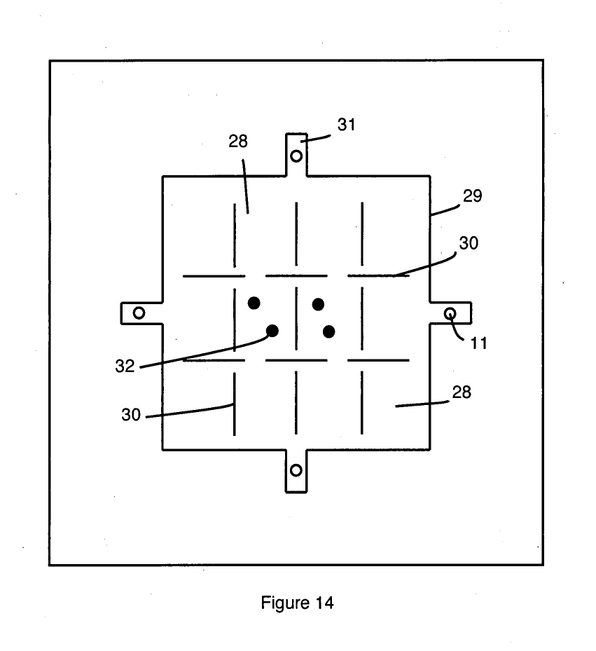

In another alternative embodiment, the electronic circuit 1 is distributed over a plurality of elementary membranes that each bear a sensitive part of the electronic circuit. FIG. 14 schematically represents an example of arrangement of the support elements of the elementary membranes (not represented). Each elementary membrane is associated with a corresponding first elementary cavity 28, rectangular in FIG. 14, and all the first elementary cavities 28 communicate with one another. The second cavity 4, not represented in FIG. 14, is common to all the elementary membranes.

In FIG. 14, the elementary cavities 28 are delineated, inside a peripheral support fillet 29, by anchoring fillets 30. The peripheral fillet 29 is substantially square and the anchoring fillets 30 form non-joining internal walls so as to allow communication between two adjacent first elementary cavities 28. The peripheral support fillet 29 and the anchoring fillets 30, filled with silicon nitride, can be formed in the same way as the previously described fillet 21. The first elementary cavities 28 can, like the previously described first cavity 3, be formed in a sacrificial layer of silicon oxide through communication holes 11. In FIG. 14, four communication holes 11 are provided in four outwardly salient recesses 31 of the walls of the peripheral fillet 29.

Abutment pillars 32, also made of silicon nitride, can be optionally provided to secure the membrane above certain elementary cavities 28 (in the central part in FIG. 14), so as to keep a part of the volume of the first cavity constant. The pressure variation arising from deformation of the non-secured elementary membranes can thereby be limited.

The invention is not limited to the particular embodiments described above. In particular, it is possible to combine distribution of the electronic circuit on elementary membranes and formation of weakening grooves. The latter can for example be formed above the peripheral fillet 29 or the anchoring fillets 30.

1. Method for protecting an electronic chip, wherein at least a part of an electronic circuit of the chip is formed on a thin rigid membrane arranged between first and second cavities, normally at a substantially identical pressure that is much higher than atmospheric pressure, an attempted intrusion causing a reduction of the pressure in one of the cavities creating a pressure difference that breaks the membrane.

2. Self-protected electronic chip for implementation of the method according to claim 1, wherein at least a part of an electronic circuit of the chip is formed on a thin rigid membrane arranged between first and second cavities in which the pressure is normally much higher than atmospheric pressure.

3. Chip according to claim 2, wherein the pressure in the first and second cavities is about ten bars.

4. Chip according to claim 2, wherein the first cavity being located under the membrane, the second cavity is located between the membrane and a protective cover.

5. Chip according to claim 2, wherein the membrane is formed by a thin layer of silicon.

6. Chip according to claim 2, wherein the membrane comprises previously weakened zones.

7. Chip according to claim 2, wherein the electronic circuit comprises a plurality of sensitive parts distributed over a plurality of elementary membranes associated with corresponding first elementary cavities, said first elementary cavities communicating with one another and with a second cavity common to all the elementary membranes.

8. Method for producing a chip according to claim 2, wherein it comprises formation of at least one communication hole passing through the membrane, pressurization of the first and second cavities connected by means of said communication hole, and sealing of said communication hole.

9. Method according to claim 8, wherein said electronic circuit being formed, in silicon on insulator technology, on a front face of a substrate comprising a buried oxide layer, the first cavity, located under the membrane, is formed by etching of the rear face of the substrate, with stopping on the buried oxide.

10. Method according to claim 8, wherein
said electronic circuit is formed, in silicon on insulator technology, on a front face of a substrate comprising a buried oxide layer between a rear silicon layer and a front silicon layer,
a fillet, passing through the front silicon layer and the buried oxide layer, is etched around said part of the circuit and laterally delineates the membrane in said front silicon layer,
the fillet is filled with silicon nitride,
the communication hole is formed in the front silicon layer,
the first cavity, located under the membrane and laterally delineated by said fillet, is formed in the buried oxide layer by etching of the buried oxide layer through the communication hole.

11. Method according to claim 10, wherein weakening trenches, with a width of less than one micron and passing through the front silicon layer, are etched and filled with silicon nitride at the same time as the fillet, etching of the buried oxide layer to form the first cavity resulting in at least partial etching of the silicon nitride of the fillet and of the weakening trenches.

12. Method according to claim 10, wherein the front silicon layer is thickened by epitaxy before formation of said part of the chip on the front face of the substrate.

13. Method according to claim 8, wherein the second cavity is arranged between the membrane and a protective cover, said protective cover being sealed under said pressure, that is much higher than atmospheric pressure, by means of a sealing fillet covering said communication hole.

14. Method according to claim 8, wherein the second cavity being located between the membrane and a protective cover, sealing of said communication hole is performed after sealing of the protective cover.

15. Method according to claim 14, wherein it comprises deposition of a polysilicate glass film on the membrane, around the communication hole and, after sealing of the protective cover, a heating step at high temperature causing creeping of said film and sealing of the communication hole by the crept glass.

16. Method according to claim 8, wherein it comprises preservation of a passage with a low hydraulic conductance, between the first and second cavities.

17. Method according to claim 16, wherein said passage is formed by sealing of the communication hole by a sufficiently porous sealing material to enable the pressures in the first and second cavities to be kept at equilibrium in the event of a slow variation of the pressures, but not porous enough to enable the pressures to be kept at equilibrium in the event of a sharp variation of the pressure in one of the cavities.

18. Method according to claim 17, wherein the sealing material is polysilicate glass.

19. Method according to claim 16, wherein said passage is formed by etching, in the membrane, of an additional hole having a diameter of less than one micron.

20. Method according to claim 16, wherein said passage is formed, on the membrane, by a capillary perpendicular to the communication hole with which it communicates and formed in a thin layer covering the communication hole.

21. Method according to claim 20, wherein said thin layer covering the communication hole and in which the capillary is formed is made of metal.
